(19) United States
(12) Patent Application Publication
(10) Pub. No.: US 2022/0111648 A1
(43) Pub. Date: Apr. 14, 2022

(54) RECORDING APPARATUS AND HOLDING CONTAINER

(71) Applicant: CANON KABUSHIKI KAISHA, Tokyo (JP)

(72) Inventors: Atsushi Matsuyama, Kanagawa (JP); Koya Iwakura, Kanagawa (JP); Hideaki Matsumura, Kanagawa (JP); Tetsu Hamano, Tokyo (JP); Nobuhiro Toki, Kanagawa (JP); Daiju Takeda, Kanagawa (JP); Fumie Kameyama, Tokyo (JP); Koki Shimada, Kanagawa (JP); Shota Asada, Tokyo (JP); Ken Takenaga, Kanagawa (JP); Yusuke Tanaka, Kanagawa (JP); Yuta Araki, Chiba (JP); Taiji Maruyama, Kanagawa (JP); Yusuke Naratani, Tokyo (JP); Kousuke Tanaka, Kanagawa (JP)

(21) Appl. No.: 17/493,630

(22) Filed: Oct. 4, 2021

(30) Foreign Application Priority Data
Oct. 9, 2020 (JP) 2020-170872

(51) Int. Cl. B41J 2/165

(52) U.S. Cl. CPC B41J 2/1652

(57) ABSTRACT

A recording apparatus includes a platen that supports a recording medium and is provided at a position facing a recording head, a holding container, detachably attached to the recording apparatus, that holds an absorber for absorbing and holding liquid discharged from the recording head, and a path member that is at least partly disposed under the platen and forms a path in which liquid flows, wherein the path member has a protrusion part configured to contact the absorber in a state where the holding container is attached to the recording apparatus.

### BACKGROUND

### Field of the Disclosure

The present disclosure generally relates to a recording apparatus that records an image, and more specifically, to a holding container of the recording apparatus.

### Description of the Related Art

Ink-jet recording apparatuses performs recovery operations including ink suction for maintaining discharge performance of the recording head. Since waste ink is generated in the recovery operations, some of the apparatuses include a waste ink tank for storing and holding the waste ink.

Japanese Patent Application Laid-Open No. 2003-11394 discusses a configuration of an ink-jet recording apparatus in which a detachable and attachable waste ink storage body detachably attached to the apparatus is coupled to a fixed waste ink storage body fixed to the apparatus. Since the ink-jet recording apparatus is provided with both the fixed waste ink storage body and the attachable and detachable waste ink storage body, the user who consumes a large amount of ink can use the ink-jet recording apparatus for a long period of time by replacing the attachable and detachable waste ink storage body. In the configuration of Japanese Patent Application Laid-Open No. 2003-11394, however, the waste ink is stored in the fixed waste ink storage body as well, so that when the attachable and detachable waste ink storage body is removed, the waste ink may be leaked to the outside of the recording apparatus from the fixed waste ink storage body if the apparatus is moved, in particular when the apparatus is tilted.

### SUMMARY

The present disclosure is addressed to reducing leakage of a liquid from an apparatus.

According to an aspect of the present disclosure, a recording apparatus includes a recording head configured to discharge liquid, a platen that supports a recording medium and is provided at a position facing a recording head, a holding container, detachably attached to the recording apparatus, that holds an absorber for absorbing and holding liquid discharged from the recording head, and a path member that is at least partly disposed under the platen and forms a path in which liquid flows, wherein the path member has a protrusion part configured to contact the absorber in a state where the holding container is attached to the recording apparatus.

Further features of the present disclosure will become apparent from the following description of exemplary embodiments with reference to the attached drawings.

### BRIEF DESCRIPTION OF THE DRAWINGS

FIG. 1 is a perspective view of an internal configuration of an ink-jet recording apparatus according to a first exemplary embodiment.

FIG. 2 is a block diagram illustrating a control system of the ink-jet recording apparatus according to the first exemplary embodiment.

FIGS. 3A and 3B are schematic perspective views of a configuration of a waste ink reservoir and the periphery thereof according to the first exemplary embodiment.

FIG. 4 is a schematic cross-sectional view of a configuration of a platen and the periphery thereof according to the first exemplary embodiment.

FIG. 5 is a schematic cross-sectional view of a configuration of the waste ink reservoir and the periphery thereof according to the first exemplary embodiment.

FIG. 6 is a perspective view of the waste ink reservoir and a recovery unit according to the first exemplary embodiment.

FIG. 7 is an upper perspective view of a detailed configuration of the waste ink reservoir according to the first exemplary embodiment.

FIGS. 8A, 8B, and 8C are schematic top views of a connecting portion between a waste ink discharge path member and the waste ink reservoir according to the first exemplary embodiment.

FIG. 9 is a flowchart of operation performed by the ink-jet recording apparatus when the waste ink reservoir is attached thereto according to the first exemplary embodiment.

FIG. 10 is a flowchart of operation performed by the ink-jet recording apparatus when the waste ink reservoir is removed therefrom according to the first exemplary embodiment.

FIGS. 11A and 11B are schematic top views of a connecting portion between a waste ink discharge path member and a waste ink reservoir according to a second exemplary embodiment.

### DESCRIPTION OF THE EMBODIMENTS

Hereinafter, exemplary embodiments of the present disclosure will be described with reference to the drawings. However, the following exemplary embodiments do not limit the present disclosure, and all of combinations of features described in the exemplary embodiments are not necessarily essential to the solutions of the present disclosure. Relative arrangements, shapes, and the like of constituent elements described in the exemplary embodiments are mere examples and are not intended to limit the scope of the present disclosure to those arrangements, shapes, and the like.

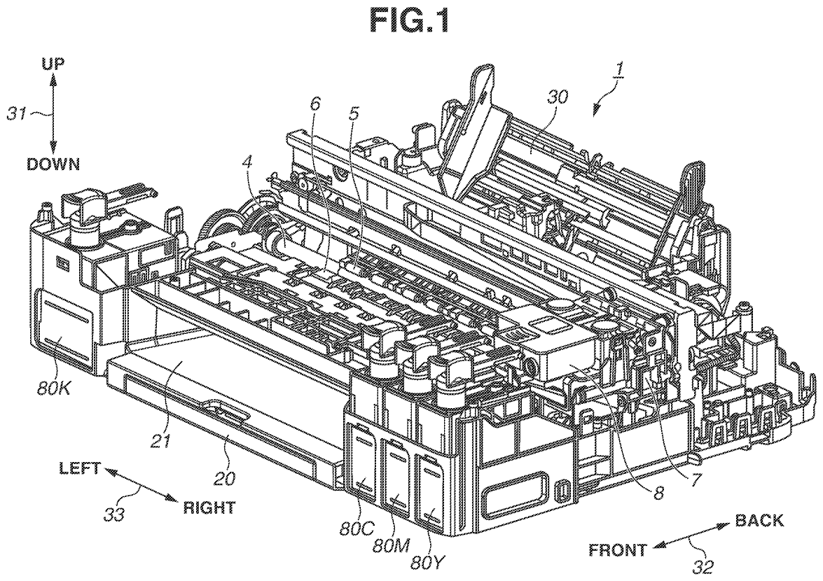

FIG. 1 is a perspective view of an internal configuration of an ink-jet recording apparatus (hereinafter referred to as recording apparatus) 1 in a first exemplary embodiment. The recording apparatus 1 includes a recording unit 8 that performs a recording operation on a recording medium, and ink tanks 80 that are ink containers containing ink to be supplied to the recording unit 8. In the present exemplary embodiment, the ink tanks 80 are arranged on the front side of the recording apparatus 1 and fixed to the apparatus body. The recording apparatus 1 also includes a cover openable/closable with respect to the housing, which is not illustrated. The cover is opened in the view illustrated in FIG. 1. The cover not illustrated may include a scanner unit capable of reading documents. In the following description, an up-down direction 31 is used as a height direction of the recording apparatus 1, a front-back direction 32 is used as a depth direction of the recording apparatus 1, and a right-left direction 33 is used as a width direction of the recording apparatus 1.

The recording apparatus 1 separates one recording medium from others loaded in a feed cassette 20 on the front side in the front-back direction 32 or a feeding tray 30 on the back side in the front-back direction 32, and feeds the separated recording medium by a feed roller (feed unit) not illustrated. The recording medium fed by the feed roller is pinched between a conveyance roller 4 as a conveyance unit and a pinch roller 5 rotating together with the conveyance roller 4, and is conveyed to a recording position facing the recording unit 8. The recording medium is conveyed by the conveyance roller 4 from the back side to front side in the front-back direction 32.

A platen 6 is arranged at a position facing the recording unit 8. With the rear side of the recording medium supported by the platen 6, the recording medium is subjected to recording by the recording unit 8 on the basis of data. The recording medium having undergone the recording by the recording unit 8 is ejected by an ejection unit (not illustrated) onto a paper ejection tray (ejection unit) 21 provided above the feed cassette 20. The platen 6 is arranged in the right-left direction 33 over a recording area where the recording medium is subjected to image recording by the recording unit 8.

The recording unit 8 in the present exemplary embodiment includes a recording head that has discharge ports from which ink is to be discharged. The recording unit 8 is mounted on a carriage 7 that reciprocates in a main scanning direction (the right-left direction 33) crossing the conveyance direction. In the present exemplary embodiment, the conveyance direction and the main scanning direction are orthogonal to each other. The recording unit 8 discharges ink droplets while moving together with the carriage 7 in the right-left direction 33, thereby to record an image of a predetermined length, i.e., an image for one band, on the recording medium (recording operation). When the image for one band has been recorded, the recording medium is conveyed by a predetermined amount by the conveyance unit (intermittent conveyance operation). Repeating the one-band recording operation and intermittent conveyance operation allows the entire image to be recorded on the recording medium based on the image data.

The recording head in the present exemplary embodiment includes units that generates thermal energy as energy to be used for ink discharge (for example, heating resistance elements), and use a method of causing a change in the state of the ink (film boiling) by the thermal energy. This achieves high-density and high-definition of image recording. However, the present exemplary embodiment is not limited to this method using thermal energy, and a method using vibration energy from a piezoelectric transducer can also be used.

In the present exemplary embodiment, the recording head in the recording unit 8 is described using a serial head as an example which is to be mounted on the carriage 7. However, the present exemplary embodiment is not limited to this example, and a line head in which a plurality of discharge ports is aligned in an area corresponding to the width of a recording medium can also be used.

The recording apparatus 1 is provided with the ink tanks 80 for different colors of ink to be discharged from the recording head of the recording unit 8. In the present exemplary embodiment, the recording apparatus 1 includes a black ink tank 80K that stores black ink, a cyan ink tank 80C that stores cyan ink, a magenta ink tank 80M that stores magenta ink, and a yellow ink tank 80Y that stores yellow ink. These four ink tanks will be collectively referred to as ink tanks 80. The cyan ink, magenta ink, and yellow ink are mere examples of color ink, and the present exemplary embodiment is not limited to these colors of ink.

As illustrated in FIG. 1, the black ink tank 80K is arranged on the left side of the paper ejection tray 21 and the feed cassette 20 in the right-left direction 33. On the other hand, the cyan ink tank 80C, the magenta ink tank 80M, and the yellow ink tank 80Y are arranged on the right side of the paper ejection tray 21 and the feed cassette 20 in the right-left direction 33. That is, the paper ejection tray 21 and the feed cassette 20 are arranged between the black ink tank 80K and the color ink tanks in the right-left direction 33. The ink tanks 80 are connected to the recording unit 8 via flexible supply tubes (not illustrated) constituting supply flow paths for supplying the ink to the recording unit 8.

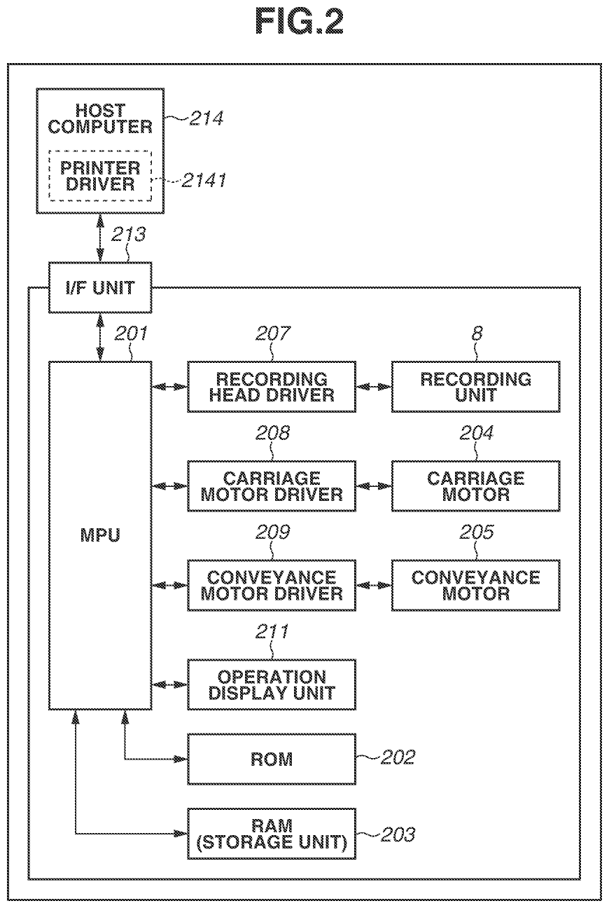

FIG. 2 is a block diagram of a control system of the recording apparatus 1. A micro processing unit (MPU) 201 controls the entire recording apparatus 1 to perform operations and data processing of the units. A read only memory (ROM) 202 stores programs to be executed by the MPU 201 and various data. A random access memory (RAM) 203 temporarily stores processing data to be executed by the MPU 201 and data received from a host computer 214.

The recording unit 8 is controlled by a recording head driver 207. A carriage motor 204 for driving the carriage 7 is controlled by a carriage motor driver 208. The conveyance roller 4 and an ejection roller are driven by a conveyance motor 205. The conveyance motor 205 is controlled by a conveyance motor driver 209.

The host computer 214 includes a printer driver 2141 for, when the execution of a recording operation is ordered by the user, collecting recording images and recording information such as recording image quality, and transmitting the images and information to the recording apparatus 1. The MPU 201 exchanges the recording images and the like with the host computer 214 via an I/F unit 213. The recording apparatus 1 further includes an operation display unit 211 with which the user can perform an operation such as inputting of a command to the recording apparatus 1. The operation display unit 211 can notify the user of an error having occurred in the recording apparatus 1 by displaying, for example, an error message.

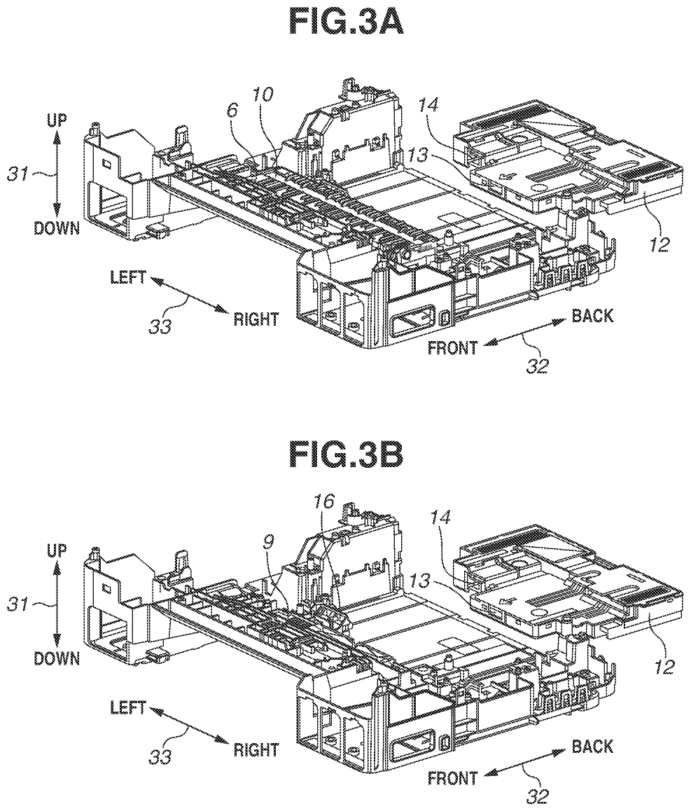

FIGS. 3A and 3B are schematic perspective views of a configuration of a waste ink reservoir 12 and the periphery thereof in the present exemplary embodiment. FIG. 3A illustrates the recording apparatus 1 with the platen 6, and FIG. 3B illustrates the recording apparatus 1 in a state where the platen 6 and an ink reception member 10 are removed. The recording apparatus 1 of the present exemplary embodiment can perform marginless recording by which the ink is discharged up to the outside of the recording medium to make image recording on the entire recording medium. The ink discharged to the outside of the recording medium for marginless recording is received by the ink reception member 10 exposed from the support surface of the platen 6. The ink reception member 10 is made of, for example, a material with good absorbency and transmittivity such as urethane foam.

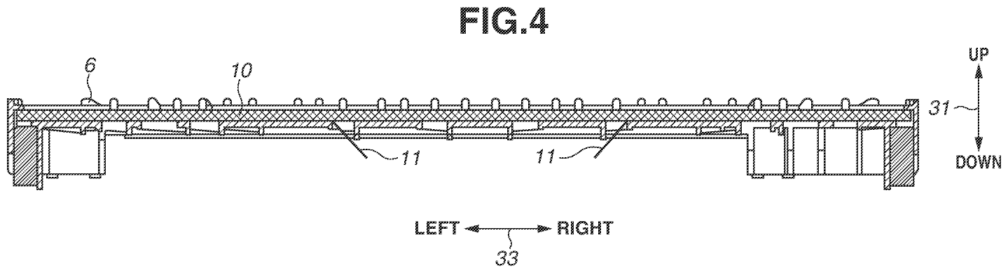

FIG. 4 is a schematic cross-sectional view of a configuration of the platen 6 and the periphery thereof. The ink received by the ink reception member 10 is discharged by bridge sheets 11 as waste ink transfer members to a waste ink discharge path member 9 arranged under the platen 6. The bridge sheets 11 are sheet members that are arranged under the platen 6 and the ink reception member 10, and have drooping parts (transfer portions) that suspend downward to direct the ink received by the ink reception member 10 in the downward direction. The ink reception member 10 and the bridge sheets 11 can absorb a predetermined amount of ink. If the absorbed ink exceeds the predetermined amount, the ink drops into the waste ink discharge path member 9 via the drooping parts of the bridge sheets 11. The bridge sheets 11 are made of pulp, for example.

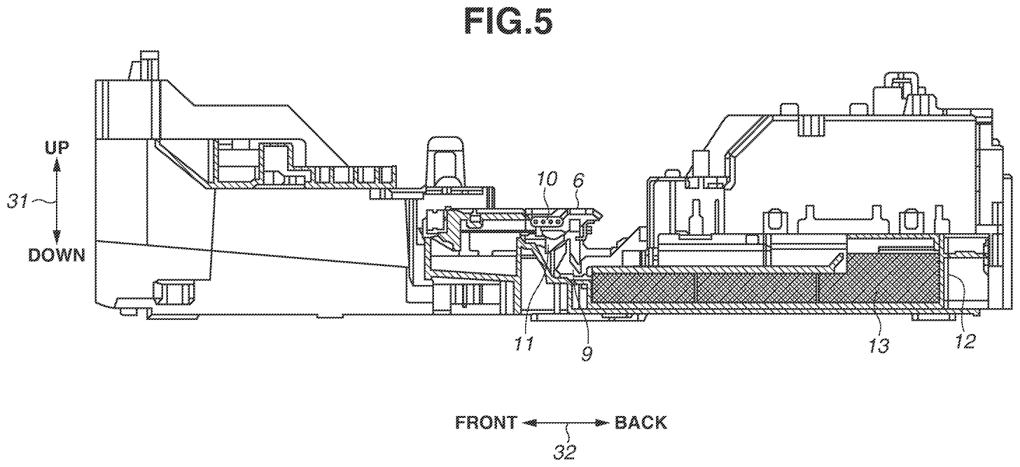

FIG. 5 is a schematic cross-sectional view of a configuration of the waste ink reservoir 12 and the periphery thereof. The waste ink discharge path member 9 is a member with low ink absorbency (incapable of absorbing ink) made of resin or the like, and has a sloped shape for guiding the waste ink dropped from the bridge sheets 11 to the waste ink reservoir 12. The waste ink reservoir 12 is an ink container that is attachable to and detachable from the recording apparatus 1 in the front-back direction 32, and is attached to the apparatus by the user inserting the waste ink reservoir 12 from the back to front of the recording apparatus 1. In a reverse manner, the user can remove the waste ink reservoir 12 from the recording apparatus 1 by drawing the waste ink reservoir 12 rearward.

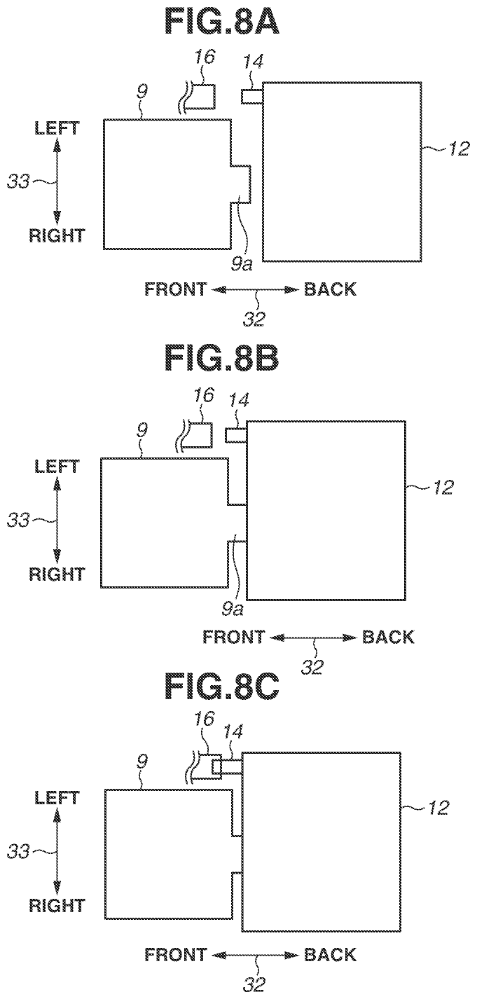

The waste ink reservoir 12 further includes an absorber 13 that is capable of absorbing and holding the ink flowing from the waste ink discharge path member 9 (protrusion part 9a) and a detection sensor 14 that is a detection unit for detecting the state of attachment to the recording apparatus 1 (see FIGS. 8A to 8C). The main body of the recording apparatus 1 includes a detection target part 16 that comes in contact with the detection sensor 14 when the waste ink reservoir 12 is inserted into an appropriate attachment position. The MPU 201 determines that the waste ink reservoir 12 is attached if the contact between the detection sensor 14 and the detection target part 16 is detected. In contrast, when the waste ink reservoir 12 is removed by the user from the attachment position, the detection sensor 14 and the detection target part 16 are brought into a non-contact state, and thus the MPU 201 determines that the waste ink reservoir 12 is not attached.

As described above, in the present exemplary embodiment, the ink discharged outside the area of the recording medium is received by the ink reception member 10, and then is introduced into the waste ink discharge path member 9 as a flow path member. The ink having been introduced into the waste ink discharge path member 9 is guided to the protrusion part 9a along the sloped surface, and then is absorbed by the absorber 13 with high ink absorbency, which is configured to contact the protrusion part 9a. The absorber 13 provided in the waste ink reservoir 12 attachable to and detachable from the recording apparatus 1 can be easily replaced if an amount of ink equal to or larger than a threshold is introduced.

Therefore, as compared to the conventional case, there is substantially no limitation on the amount of ink receivable on the platen 6, which eliminates the necessity for arranging a large-capacity absorber under the platen 6. This increases the amount of ink receivable on the platen 6 while achieving the downsizing of the recording apparatus 1.

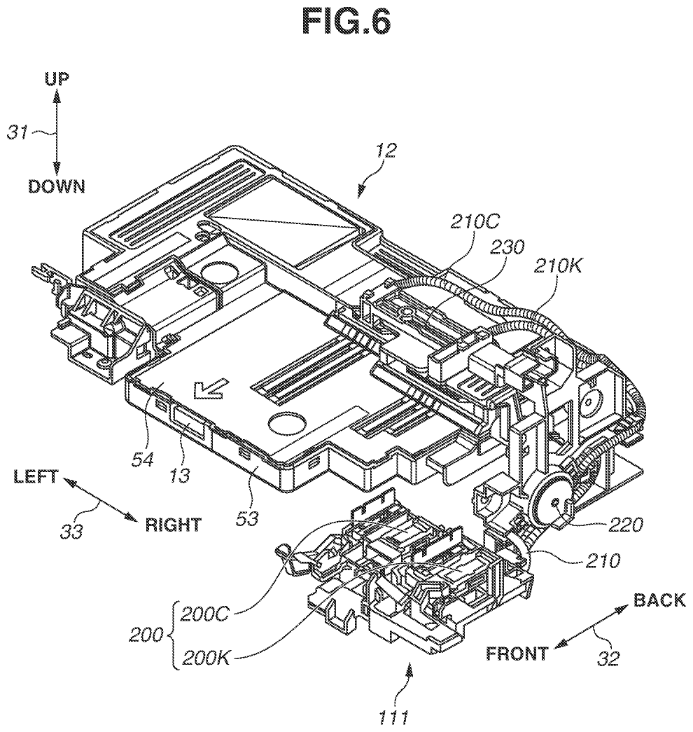

FIG. 6 is a perspective view of the waste ink reservoir 12 and a recovery unit 111. The recording apparatus 1 includes the recovery unit 111 that performs recovery operations for maintaining the ink discharge performance of the recording unit 8. The recovery unit 111 is provided in a recovery area outside the recording area and adjacent to the recording area.

The recovery unit 111 includes caps 200 that cap discharge port surfaces (not illustrated) of the recording unit 8 (recording head) to protect the discharge ports from which ink is to be discharged, for example. The recording unit 8 according to the present exemplary embodiment has two types of recording heads, i.e., a black recording head that discharges black ink and a color recording head that discharges color ink, both of which have their respective discharge ports. Thus, the caps 200 include a black cap 200K for the black recording head and a color cap 200C for the color recording head. Hereinafter, the two caps will be collectively called caps 200.

The recovery unit 111 further includes suction tubes 210 connected to the caps 200 and a suction pump 220 for sucking the ink from the recording unit 8 (recording heads) via the suction tubes 210. The suction tubes 210 include a black suction tube 210K connected to the black cap 200K and a color suction tube 210C connected to the color cap 200C. The suction tubes 210 are connected to a flow path member 230, and waste ink is introduced into corresponding openings (described below) of the waste ink reservoir 12 by the flow path member 230.

The recovery operations on the recording unit 8 include a suction operation in which the suction pump 220 is driven with the discharge port surfaces sealed by the caps 200 to suck the ink through the discharge ports. By performing the suction operation, the air bubbles and thickened ink in the discharge ports can be forcibly sucked and discharged.

The recovery operations further include a preparatory discharge operation in which the recording unit 8 discharges the ink not for the purpose of the recording operation in a state of facing the caps 200. The recording unit 8 according to the present exemplary embodiment performs the preparatory discharge operation with respect to the caps 200. Alternatively, the recording unit 8 may perform the preparatory discharge operation with respect to an ink reception part provided separately from the caps 200. By performing the preparatory discharge operation, the thickened ink in the discharge ports of the recording heads can be forcibly discharged. The ink preparatorily discharged to the caps 200 is discharged to the waste ink reservoir 12 by driving the suction pump 220.

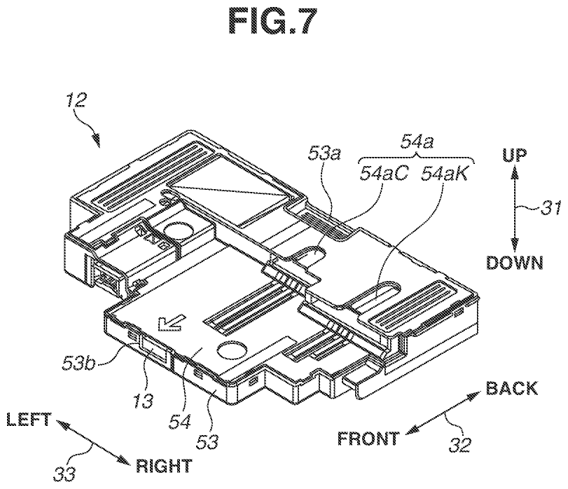

FIG. 7 is an upper perspective view of a detailed configuration of the waste ink reservoir 12. Besides the absorber 13 described above, the waste ink reservoir 12 has a substantially box-shaped container 53 that is opened at the top to store the absorber 13 therein, and a lid 54 attached to cover the opening in the container 53. The container 53 includes a cutout 53b for exposing the absorber 13. That is, the cutout 53b is an introduction part for introducing the ink from the waste ink discharge path member 9 to the absorber 13.

Waste ink introduction parts (openings) 54a are formed at the top surface portion of the waste ink reservoir 12, i.e., at the lid 54 in order to introduce the waste ink from the flow path member 230 to the container 53. The waste ink introduction parts 54a include a black ink introduction part 54aK through which the waste ink discharged from the black suction tube 210K is to be introduced and a color ink introduction part 54aC through which the waste ink discharged from the color suction tube 210C is to be introduced. The black ink introduction part 54aK and the color ink introduction part 54aC are disposed at respective positions separated from each other.

The waste ink sucked from the recording unit 8 by the suction pump 220 is introduced into the waste ink reservoir 12 from the flow path member 230 via the waste ink introduction parts 54a, and is absorbed and held by the absorber 13. If the amount of accumulated waste ink measured by a waste ink counter included in the control unit (the MPU 201) of the recording apparatus 1 exceeds a threshold, the user is notified that the waste ink reservoir 12 needs replacement by an indication on the operation display unit 211 or the like. The user removes the waste ink reservoir 12 full of the waste ink from the recording apparatus 1 and attaches a new waste ink reservoir 12. The waste ink counter counts the amount of waste ink discharged into a waste ink tank 51 by the suction operation and the preparatory discharge operation performed as the recovery operations.

As above described, the ink discharged at the position facing the platen 6 is guided to the attachable and detachable waste ink reservoir 12, so that, even if the recording apparatus 1 is tilted with the waste ink reservoir 12 removed therefrom, it is possible to reduce leakage of ink from the recording apparatus 1.

In the present exemplary embodiment, both the ink discharged at the position facing the platen 6 and the ink discharged by the recovery operations are absorbed and held in the user-attachable and detachable waste ink reservoir 12. That is, the waste ink reservoir 12 has the introduction parts from which the ink discharged in the recording area and the ink discharged in the recovery area are introduced. Accordingly, the waste ink generated at a plurality of places by the operations of the recording apparatus 1 can be held in one reservoir.

FIGS. 8A, 8B, and 8C are schematic top views of a connecting portion between the waste ink discharge path member 9 and the waste ink reservoir 12 in the first exemplary embodiment. The attachment operation of the waste ink reservoir 12 by the user is illustrated in the order of FIGS. 8A to 8C, and the removal operation of the waste ink reservoir 12 by the user is illustrated in the order of FIG. 8C to 8A.

The waste ink discharge path member 9 has a protrusion part 9a that protrudes backward in the front-back direction 32 at a position facing the absorber 13 exposed from the cutout 53b of the waste ink reservoir 12. FIG. 8A illustrates the state of the connecting portion at the time when the user starts the attachment operation of the waste ink reservoir 12. At this time, the protrusion part 9a and the absorber 13 are separated from each other, and the detection sensor 14 and the detection target part 16 are also separated from each other.

As the user inserts the waste ink reservoir 12 forward, the protrusion part 9a and the absorber 13 contact each other first as illustrated in 8B. However, since the detection sensor 14 and the detection target part 16 do not contact each other, the detection sensor 14 does not yet detect the attachment of the waste ink reservoir 12.

Thereafter, as the user inserts the waste ink reservoir 12 further forward, the protrusion part 9a is inserted into the absorber 13 and placed in an appropriate attachment position as illustrated in FIG. 8C. When the waste ink reservoir 12 is attached in the appropriate attachment position, the detection sensor 14 and the detection target part 16 contact each other so that the detection sensor 14 detects that the waste ink reservoir 12 is attached. In this manner, the detection sensor 14 and the detection target part 16 contact in the same direction (the front-back direction 32) as the direction in which the protrusion part 9a and the absorber 13 contact each other.

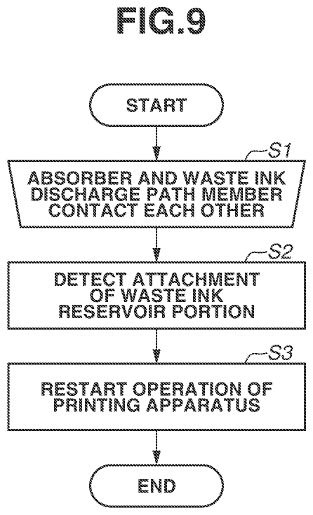

FIG. 9 is a flowchart of operation by the recording apparatus 1 when the waste ink reservoir 12 is attached thereto. In step S1, the absorber 13 and the protrusion part 9a of the waste ink discharge path member 9 are brought into contact with each other by the user operation as illustrated in FIG. 8B. Thereafter, the detection sensor 14 and the detection target part 16 contact each other as illustrated in FIG. 8C. In step S2, the detection sensor 14 detects that the waste ink reservoir 12 is attached. Then, in step S3, the recording apparatus 1 restarts the recording operation or the recovery operation.

Accordingly, after the waste ink reservoir 12 is appropriately attached in the attachment position, the waste ink is introduced from the recovery unit 111 into the waste ink reservoir 12, thereby reducing ink leakage from the recording apparatus 1.

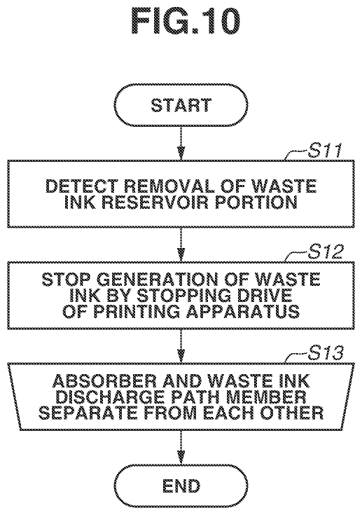

FIG. 10 is a flowchart of operation by the recording apparatus 1 when the waste ink reservoir 12 is removed therefrom. In step S11, the detection sensor 14 and the detection target part 16 are separated from each other by the user's removal operation, and the detection sensor 14 detects that the waste ink reservoir 12 is removed. At this time, the protrusion part 9a and the absorber 13 are not yet separated from each other. With the detection by the detection sensor 14 as a trigger, in step S12, the recording apparatus 1 stops the recording operation or the recovery operation to stop generation of the waste ink. Thereafter, in step S13, the protrusion part 9a and the absorber 13 are separated from each other by the user's removal operation.

Since the generation of the waste ink can be stopped before the protrusion part 9a and the absorber 13 are separated from each other, it is possible to reduce ink leakage from the recording apparatus 1 at the time of removal of the waste ink reservoir 12.

The position of contact between the protrusion part 9a and the absorber 13 and the position of contact between the detection sensor 14 and the detection target part 16 are arranged so as not to overlap (arranged at different positions) in the right-left direction 33. Accordingly, if the waste ink reservoir 12 is moved in the front-back direction 32 by the user's attachment/detachment operation, the detection sensor 14 is arranged at a position off the movement path of the waste ink reservoir 12 (the absorber 13) that receives the ink from the protrusion part 9a. It is thus possible to prevent the detection sensor 14 from being contaminated by the ink leaked from the absorber 13 during the removal of the waste ink reservoir 12.

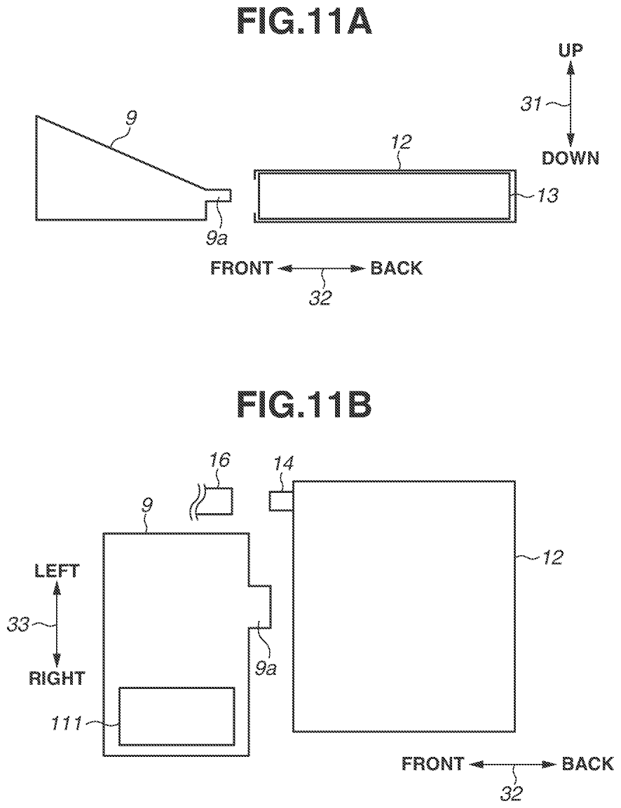

Hereinafter, a second exemplary embodiment of the present disclosure will be described with reference to FIGS. 11A and 11B. FIG. 11A is a schematic cross-sectional view of a connecting portion between a waste ink discharge path member 9 and a waste ink reservoir 12, and FIG. 11B is a schematic top view of the connecting portion therebetween.

In the first exemplary embodiment, the ink discharged from the recovery unit 111 is introduced into the waste ink reservoir 12 via the suction tubes 210. In the second exemplary embodiment, the ink sucked and discharged by a recovery unit 111 drops into the waste ink discharge path member 9, and then is guided from a protrusion part 9a along the sloped surface of the waste ink discharge path member 9 and introduced into the absorber 13. That is, the waste ink discharge path member 9 is arranged not only under the platen 6 but also under the recovery unit 111.

Accordingly, the ink from the recovery unit 111 is also discharged into the attachable and detachable waste ink reservoir 12, which eliminates the need to arrange a large-capacity absorber under the recovery unit 111. This realizes downsizing of the recording apparatus 1. In addition, since there is no upper limit on the absorbable amount of ink discharged from the recovery unit 111, the user can use the recording apparatus 1 for a long period of time.

In the second exemplary embodiment, similarly to the first exemplary embodiment, at the time of attachment of the waste ink reservoir 12, the protrusion part 9a and the absorber 13 contact each other first, and then a detection sensor 14 and a detection target part 16 contact each other. At the time of removal of the waste ink reservoir 12, the separation of the detection sensor 14 and the detection target part 16 are separated from each other first, and then the protrusion part 9a and the absorber 13 are separated from each other. The position of contact between the protrusion part 9a and the absorber 13 and the position of contact between the detection sensor 14 and the detection target part 16 are arranged so as not to overlap in the right-left direction 33. According to the configuration described above, it is possible to reduce ink leakage from the recording apparatus 1 as in the first exemplary embodiment.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2020-170872, filed Oct. 9, 2020, which is hereby incorporated by reference herein in its entirety.

What is claimed is:

1. A recording apparatus comprising:
a recording head configured to discharge liquid;
a platen that supports a recording medium and is provided at a position facing the recording head;
a holding container, detachably attached to the recording apparatus, that holds an absorber for absorbing and holding liquid discharged from the recording head; and
a path member that is at least partly disposed under the platen and forms a path in which liquid flows,
wherein the path member has a protrusion part configured to contact the absorber in a state where the holding container is attached to the recording apparatus.

2. The recording apparatus according to claim 1, further comprising a detection target part configured to contact a detection unit of the holding container in a state where the holding container is attached to the recording apparatus,
wherein, when the holding container is being attached to the recording apparatus, the detection unit and the detection target part contact each other after the protrusion part and the absorber contact each other, and
wherein, when the holding container is being removed from the recording apparatus, the protrusion part and the absorber separate from each other after the detection unit and the detection target part separate from each other.

3. The recording apparatus according to claim 2, wherein the detection unit and the detection target part contact each other in a same direction as a direction in which the protrusion part and the absorber contact each other.

4. The recording apparatus according to claim 2,
wherein the holding container is attached to and detached from the recording apparatus along a first direction; and
wherein a position of contact between the detection unit and the detection target part is different from a position of contact between the protrusion part and the absorber in a second direction crossing the first direction.

5. The recording apparatus according to claim 2, wherein, when the detection unit and the detection target part separate from each other, the recording head stops a recording operation which discharges liquid.

6. The recording apparatus according to claim 5, wherein, when the detection unit and the detection target part contact each other, the recording head restarts the recording operation.

7. The recording apparatus according to claim 2, further comprising a recovery unit configured to perform a recovery operation for the recording head, wherein, when the detection unit and the detection target part separate from each other, the recovery unit stops the recovery operation.

8. The recording apparatus according to claim 7, wherein, when the detection unit and the detection target part contact each other, the recovery unit restarts the recovery operation.

9. The recording apparatus according to claim 1, further comprising a recovery unit configured to perform a recovery operation for the recording head,
wherein the path member is disposed under the recovery unit.

10. The recording apparatus according to claim 1, further comprising:
a reception member configured to be exposed from the platen and absorb and transmit the liquid discharged from the recording head; and
a sheet member that has a transfer portion configured to transfer the liquid received by the reception member to the path member.

11. The recording apparatus according to claim 1, further comprising a recovery unit configured to perform a recovery operation for the recording head,
wherein the holding container has an introduction part configured to introduce a liquid discharged from the recovery unit thereto.

12. The recording apparatus according to claim 1, wherein the path member is formed of a material lower in liquid absorbency than the absorber.

13. A holding container configured to be detachably attached to a recording apparatus including a recording head to discharge liquid, a platen that supports a recording medium and is provided at a position facing the recording head, a platen that supports a recording medium and is provided at a position facing the recording head, and a path member that is at least partly disposed under the platen and forms a path in which liquid flows, the holding container comprising:
an absorber for absorbing and holding liquid;
wherein the absorber contacts a protrusion part included in the path member when the holding container is attached to the recording apparatus.

14. The holding container according to claim 13, further comprising a detection unit configured to contact a detection target part provided in the recording apparatus when the holding container is attached to the recording apparatus,
wherein, when the holding container is being attached to the recording apparatus, then the detection unit and the detection target part contact each other after the protrusion part and the absorber contact each other, and
wherein, when the holding container is being removed from the recording apparatus, the protrusion part and the absorber separate from each other after the detection unit and the detection target part separate from each other.

15. The holding container according to claim 14, wherein the detection unit and the detection target part contact each other in a same direction as a direction in which the protrusion part and the absorber contact each other.

16. The holding container according to claim 14,
wherein the holding container is attached to and detached from the recording apparatus along a first direction, and
wherein a position of contact between the detection unit and the detection target part is different from a position of contact between the protrusion part and the absorber in a second direction crossing the first direction.

17. The holding container according to claim 13, wherein the absorber is higher in absorbency than a material of which the path member is formed.
